(19) United States
(12) Patent Application Publication
(10) Pub. No.: US 2016/0148219 A1
(43) Pub. Date: May 26, 2016

(54) Systems and Methods for Providing Consumer Networks Based on Transaction Data for Consumers

(71) Applicant: MASTERCARD INTERNATIONAL INCORPORATED, Purchase, NY (US)

(72) Inventor: Rohit Chauhan, Somers, NY (US)

(21) Appl. No.: 14/552,251

(22) Filed: Nov. 24, 2014

(51) Int. Cl. G06Q 30/02

(52) U.S. Cl. CPC G06Q 30/0201

(57) ABSTRACT

Systems and methods are directed toward providing a consumer network, and links between consumers in the network, based on transaction data for consumers. The system generally includes a memory having a data structure of consumers and transaction data associated with the consumers, and a processor coupled to the memory. The processor is configured to execute instructions, stored in the memory, to cause the processor to access transaction data from the data structure for a group of consumers, link consumers in the group based on the transaction data for the consumers, and associate the linked consumers within a consumer network. Each linked consumer in the consumer network is able to view one or more products purchased by at least another linked consumer in the consumer network.

### FIELD

The present disclosure generally relates to systems and methods for use in providing networks of consumers, and linking select ones of the consumers in the network together, based on, at the least, transaction data for the consumers.

### BACKGROUND

This section provides background information related to the present disclosure which is not necessarily prior art.

Payment accounts are used, by consumers, to purchase a variety of different goods and services from merchants. The payment accounts are generally associated with credit cards, debit cards, prepaid cards, and other payment forms, which are used to post transactions to the payment accounts. Transactions to such payment accounts are subject to approval or rejection, by communication of the transactions through a payment network. Different entities involved in processing the transactions through the payment network often gather information related to the transactions. Separately, people are known to participate in social networks as a way to interact with friends, relatives, and others.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in providing a consumer network and linking select ones of the consumers within the network together based on, at the least, transaction data for the consumers;

FIG. 2 is a block diagram of a computing device that may be used in the exemplary system of FIG. 1;

FIG. 3 is an exemplary method, suitable for use with the system of FIG. 1, for providing the consumer network and the links between select ones of the consumers within the network; and

FIG. 4 is a block diagram of an exemplary consumer network provided in accordance with the method of FIG. 3.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

Consumers often enter into transactions with merchants, which are funded by payment accounts, to purchase products (e.g., goods and/or services, etc.) from the merchants. Often times, consumers may have trouble identifying products to purchase. And, prior to such transactions, the consumers may then search for data (e.g., reviews, specifications, prices, etc.) relating to the products they intend to purchase or relating to merchants with whom they intended to transact. The systems and methods herein provide networks of consumers with similar (or related) purchasing behaviors and/or preferences, to allow the consumers to share, with other consumers, the products they have purchased and data relating to products previously purchased, or relating to merchants with whom the consumers previously transacted. As such, the consumer networks can provide platforms for consumers to identify products to purchase and/or obtain data relating to products and/or services they intend to purchase. The consumer networks can also provide platforms for merchants (e.g., merchants with whom the consumers transact, etc.) to evaluate trends or other patterns in consumer transactions.

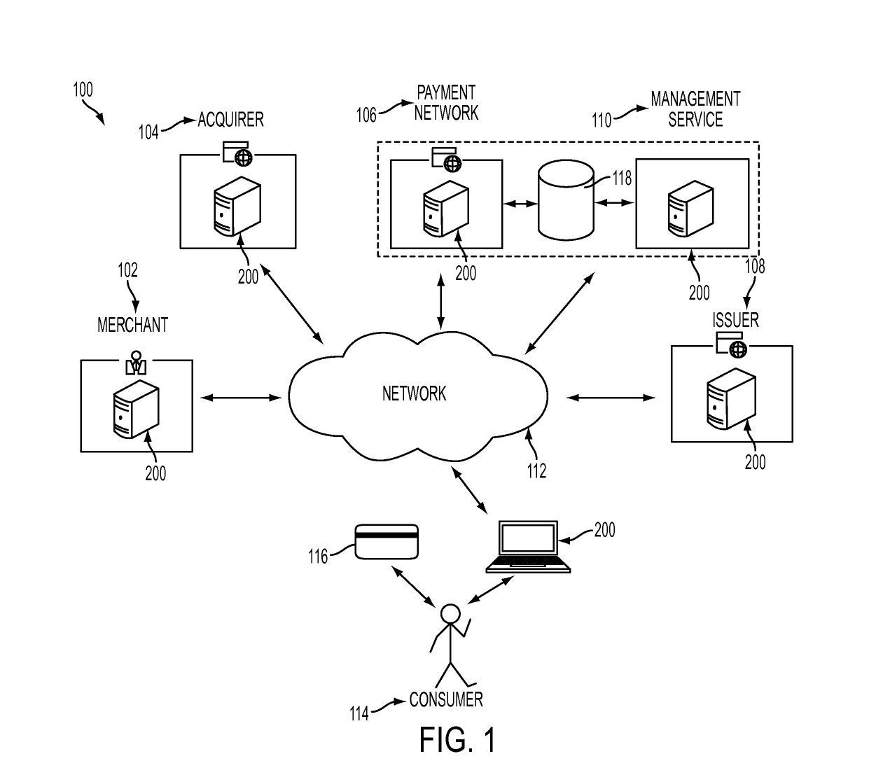

With reference now to the drawings, FIG. 1 illustrates an exemplary system 100, in which one or more aspects of the present disclosure may be implemented. The system 100 is suitable for use in providing a consumer network and linking consumers within the network based on collected transaction data for multiple consumers, where the consumers (and more particularly the linked consumers) included in the network have similar purchasing behaviors or preferences.

Although components of the system 100 are presented in one arrangement, it should be appreciated that other exemplary embodiments may include the same or different components arranged otherwise, for example, depending on associations between various components of the system 100, manners of compiling transaction data, authorization processes for payment transactions, etc.

As shown in FIG. 1, the illustrated system 100 generally includes a merchant 102, an acquirer 104, a payment network 106, an issuer 108, and a management service 110, each coupled to network 112. While one consumer and one merchant 102 are illustrated in the system 100, it should be appreciated that the system 100 is intended to accommodate multiple consumers and multiple merchants, particularly in connection with use of the system 100 to provide the consumer network as described herein.

The network 112 of the system 100 may include, without limitation, a wired and/or wireless network, one or more local area network (LAN), wide area network (WAN) (e.g., the Internet, etc.), mobile network, other network as described herein, and/or other suitable public and/or private network capable of supporting communication among two or more of the illustrated components, or any combination thereof. In one example, the network 112 includes multiple networks, where different ones of the multiple networks are accessible to different ones of the illustrated components in FIG. 1.

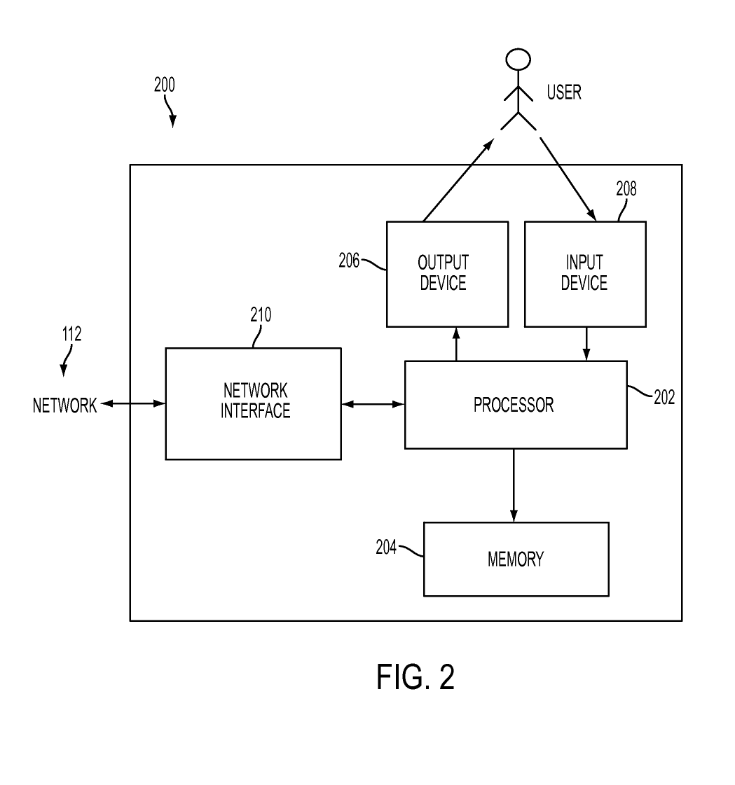

Each of the merchant 102, the acquirer 104, the payment network 106, the issuer 108, and the management service 110 of the system 100 may be implemented in one or more computing devices. For illustration, the system 100 is described with reference to exemplary computing device 200, illustrated in FIG. 2. However, the system 100, and its components should not be considered to be limited to the computing device 200, as different computing devices and/or arrangements of computing devices may be used. In addition, different components and/or arrangements of components may be used in other computing devices. Further, in various exemplary embodiments, the computing device 200 may include multiple computing devices located in close proximity, or distributed over a geographic region. Additionally, each computing device 200 may be coupled to a network (e.g., the Internet, an intranet, a private or public LAN, WAN, mobile network, telecommunication networks, combinations thereof, or other suitable network, etc.) that is either part of the network 112, or separate therefrom.

By way of example, the exemplary computing device 200 may include one or more servers, personal computers, laptops, tablets, PDAs, telephones (e.g., cellular phones, smartphones, other phones, etc.), point of sale (POS) terminals, combinations thereof, etc. as appropriate.

As shown in FIG. 2, the illustrated computing device 200 includes a processor 202 and a memory 204 that is coupled to the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and thus are not intended to limit in any way the definition and/or meaning of processor.

The memory 204, as described herein, is one or more devices that enable information, such as executable instructions and/or other data, to be stored and retrieved. The memory 204 may include one or more computer-readable media, such as, without limitation, dynamic random access memory (DRAM), static random access memory (SRAM), read only memory (ROM), erasable programmable read only memory (EPROM), solid state devices, flash drives, CD-ROMs, thumb drives, tapes, flash drives, hard disks, and/or any other type of volatile or nonvolatile physical or tangible computer-readable media. The memory 204 may be configured to store, without limitation, data relating to consumers, consumer transactions (e.g., transaction data, etc.), merchants, products and/or services purchased by the consumers and/or sold by the merchants, and/or other types of data suitable for use as described herein, etc.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer-readable media. It should be appreciated that the memory 204 may include a variety of different memories, each implemented in one or more of the functions or processes described herein.

In the exemplary embodiment, the computing device 200 includes an output device 206 that is coupled to the processor 202. The output device 206 outputs to a user (e.g., consumer 114, individuals associated with the merchant 102, individuals associated with the acquirer 104, individuals associated with the payment network 106, individuals associated with the issuer 108, individuals associated with the management service 110, etc.) by, for example, displaying, audibilizing, and/or otherwise outputting information such as, but not limited to, consumer data, transaction data, merchant data, product and/or service data, and/or any other type of data. It should be further appreciated that, in some embodiments, the output device 206 comprises a display device such that various interfaces (e.g., webpages, etc.) may be displayed at computing device 200, and in particular at the display device, to display such information and data, etc. And in some examples, the computing device 200 may cause the interfaces to be displayed at a display device of another computing device, including, for example, a server hosting a website having multiple webpages, etc. With that said, output device 206 may include, without limitation, a liquid crystal display (LCD), a light-emitting diode (LED) display, an organic LED (OLED) display, an “electronic ink” display, speakers, combinations thereof, etc. In some embodiments, output device 206 includes multiple devices.

The computing device 200 also includes an input device 208 that receives input from the user. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in some exemplary embodiments, a touch screen, such as that included in a tablet, a smartphone, or similar device, behaves as both output device 206 and input device 208. In at least on exemplary embodiment, the output device and input device are omitted.

In addition, the illustrated computing device 200 includes a network interface 210 coupled to the processor 202 and the memory 204. The network interface 210 may include, without limitation, a wired network adapter, a wireless network adapter, a mobile telecommunications adapter, or other device capable of communicating to one or more different networks, including the network 112. In some exemplary embodiments, the computing device 200 includes the processor 202 and one or more network interfaces incorporated into or with the processor 202.

Referring again to FIG. 1, typically in the illustrated system 100, the merchant 102, the acquirer 104, the payment network 106, and the issuer 108 cooperate, in response to a request from the consumer 114, to complete a payment transaction for a product and/or service using a payment account. As part of the payment transaction, the consumer 114 initially provides payment account information to the merchant 102 (e.g., a payment account number, etc. via a credit card 116, or other payment device, or via login credentials for a previously established purchase account (e.g., an electronic wallet such as MasterPass™, Google Wallet, PayPass, Softcard®, etc.), etc.). The merchant 102 reads the payment account information and communicates, via the network 112, an authorization request to the payment network 106, via the acquirer 104 (associated with the merchant 102), to process the transaction (e.g., using the MasterCard® interchange, etc.). The authorization request includes various details of the transaction (e.g., transaction data, etc.) to help facilitate processing the authorization request. The payment network 106, in turn, communicates the authorization request to the issuer 108 (associated with the consumer's payment account). The issuer 108 then provides an authorization response (e.g., authorizing or declining the request) to the payment network 106, which is provided back through the acquirer 104 to the merchant 102. The transaction with the consumer 114 is then completed, or not, by the merchant 102, depending on the authorization response.

Transaction data is generated as part of the above interactions among the merchant 102, the acquirer 104, the payment network 106, the issuer 108, and the consumer 114. The transaction data may include, without limitation, a payment account number for the consumer's payment account, a payment amount for the transaction, identifier(s) for the product(s) purchased, description(s) of the product(s) purchased, a listing of products purchased in the transaction, a merchant name for the merchant 102, a merchant identification number (MID) for the merchant 102, a merchant category code (MCC), a date and/or time of the transaction, an amount of the transaction, etc. This transaction data is transmitted from the merchant 102, depending on the transaction, to the issuer 108 through the payment network 106 (e.g., as part of the authentication request, as part of a separate request, etc.).

Other payment transactions in the system 100, involving the consumer 114, the merchant 102, other consumers accommodated by the system 100 but not shown, and other merchants accommodated by the system 100 but not shown, are also processed in a similar manner to the above payment transaction between the consumer 114 and the merchant 102. And, transaction data is also generated in connection with these payment transactions.

Once generated, the transaction data may be stored in one or more different components of the system 100. In the illustrated embodiment, for example, the payment network 106 collects the transaction data and stores it in data structure 118. As such, the data structure 118 includes a compilation of the consumers and merchants involved in the payment transactions and the corresponding transaction data for the payment transactions. For the above transaction between the consumer 114 and the merchant 102 (as well as for various other transactions in the system 100), the transaction data is stored in the data structure 118 according to one or more of the payment account associated with the consumer 114, the merchant 102 (e.g., the MID for the merchant 102, etc.), or any other criteria, such that the transaction data is readily usable as described herein. It should be appreciated that the same or different transaction data may be collected and stored within other components of the system 100. In addition, while the data structure 118 is illustrated separate from the payment network 106 in the system 100, it should be appreciated that the data structure 118 may be included in the memory 204 of the payment network computing device 200 in various implementations.

Also in the illustrated system 100, the management service 110 is configured, via computer-executable instructions, for example, to access the collected transaction data and to provide a consumer network, as described herein. In particular, the payment network 106 provides the management service 110 with access to (e.g., via the network 112, via another network, etc.) the transaction data stored in the data structure 118. In various embodiments, the payment network 106 permits access to all of the transaction data stored in the data structure 118, such that all consumers and merchants associated with the system 100 and/or the payment network 106 may potentially be included in the network by the management service 110. In other embodiments, the payment network 106 provides access to transaction data stored in the data structure 118 for only select consumers (e.g., a particular group of consumers, etc.), for example, that have consented (or otherwise identified themselves as willing) to participate in the consumer network.

Upon accessing the transaction data in the data structure 118, the management service 110 correlates the consumers to be included in the consumer network, identifies links between select ones of the consumers based on the correlations, and associates the linked consumers together within the consumer network. Each consumer in the consumer network is then able, for example, to access (e.g., view, etc.) transaction data, other product data, etc. for purchased products, or as shared, posted, etc. in the consumer network by other linked consumers. It should be appreciated that, in some embodiments, the consumers in the network will have the ability to manage their network profiles with regard to what particular data is shared, or restricted.

The linked consumers within the consumer network include all of the accessible (and, in some cases only consenting) consumers who share a predefined relationship with or are uniquely correlated with each other (e.g., a predefined transaction-based relationship, a predefined social-based relationship, etc.). The links established between the select ones of the consumers are then based on strengths or characteristics of these relationships. For example, in the illustrated system 100, links are typically established for (or at least suggested for approval for) consumers having common billing addresses, consumers associated with payment transactions at three or more of the same merchants (such that the linked consumers share a similar or substantially identical merchant footprint), consumers associated with payment transactions at the same merchants on the same dates for about the same amounts and at about the same times (such that the linked consumers likely split/shared bills at the merchants), consumers that specifically request to be linked, etc. Various other bases for such links may be used including, without limitation, school relationships, other group/association relationships, other consumer linking methods, etc.

As can be appreciated, not all of the consumers in the consumer network are linked by the management service 110. The relationships between consumes may not be sufficient to warrant links. Or, for various reasons, the consumers may simply reject suggested links. In this manner, the ultimately linked consumers will generally include those with very similar or substantially the same purchasing behaviors and/or preferences. As can also be appreciated, any number of consumers may be potentially identified, by the management service 110, as having strong relationships with other consumers (depending on the bases for determining the relationships). Thus, in some cases, limitations on this number may be desired to provide more accurate, practical, manageable, etc. links. As such, it is contemplated that, in some embodiments, the links between consumers may be further filtered based on geographic regions, zip codes, or other demographic data (e.g., age, etc.), or at least such an option may be given to the consumers.

In some embodiments, the management service 110 may also provide consumers the ability to search, within the consumer network and/or within their particular group of linked consumers, for particular data (e.g., particular transaction data, other product data, etc.), etc. In addition, in some embodiments, the management service 110 may provide merchants the ability to link with consumers in the network (e.g., via invitation to the consumers, etc.). These links may be one-way, or not, to allow the merchants to view various transaction data provided by the consumers, in connection with the network, and to provide various offers, product details, etc. to the consumers. Further, in some embodiments, the management service 110 may provide merchants the ability to evaluate trends or other patterns in consumer transactions and, in some cases, even target all linked consumers with advertising, for example, based on purchases by less than all of the linked consumers (even if the merchants are not linked in the networks).

In at least one embodiment, the management service 110 permits the consumer to view non-consumer-specific product data based on a search within the consumer network (e.g., merchant level data, product level data, etc.). For example, a consumer within the consumer network may be looking for a product to purchase for a friend, a family member, or another person, or may be looking for a merchant at which to purchase the product. In this example, the consumer may search in the consumer network based on criteria of that friend, for example, age, gender, location, interest, etc., which would return trends for that profile. The non-consumer-specific trends, in this example, will be based on consumers not linked to the consumer, but which are participants in the consumer network. In this manner, the consumer uses the consumer network as a tool to search for a merchant that may be popular to consumers having similar criteria/profiles of the friend and, in some embodiments, even example/suggestions for particular products to purchase for the friend based on the friend's particular profile. As should be appreciated, any different type of criteria for such a search may be used by a consumer, and/or accepted by the management service 110, in various embodiments. In other embodiments, this search option (of non-linked consumers) may be omitted.

In the illustrated system 100, the management service 110 is shown separate from the payment network 106 (and separate from the other entities in the system 100). However, it should be understood that the management service 110 could be implemented in combination with the payment network 106 as indicated by the broken lines in FIG. 1. Additionally, or alternatively, in various embodiments, the management service 110 may be associated with (e.g., separate from but associated with, implemented in combination with, etc.) one or more of the acquirer 104, the issuer 108, or other component of the system 100, or other entity such that the acquirer 104, the issuer 108, or other component of the system 100, or other entity may collect transaction data, and/or store it in memory 204 (e.g., in a data structure, etc.), and then provide the management service 110 with access to the transaction data.

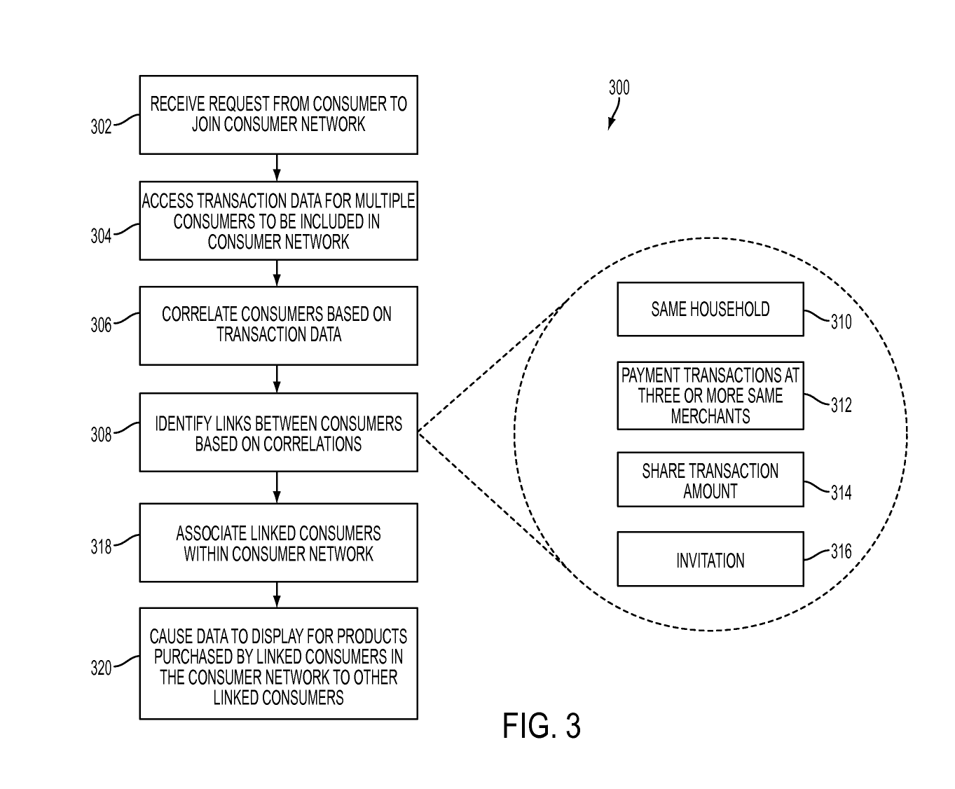

FIG. 3 illustrates an exemplary method 300 for use in providing a consumer network, and linking select ones of the consumers therein, based on collected transaction data for multiple consumers, where the linked consumers included in the network have similar purchasing behaviors and/or preferences. The linked consumers in the network can then share data with each other in the network relating to products and/or services previously purchased, or relating to merchants with whom the consumers previously transacted.

The exemplary method 300 is described as implemented in the management service 110 of the system 100 (e.g., in the computing device 200 of the management service 110, etc.), with further reference to the merchant 102, the acquirer 104, the payment network 106, the issuer 108, and the consumer 114. As described above, in at least some embodiments, the management service 110 may be included with the payment network 106 (as illustrated by the broken lines in FIG. 1), and/or with other entities, shown or not shown in FIG. 1. Further, for purposes of illustration, the exemplary method 300 is described herein with reference to the computing device 200. In addition, just as the methods herein should not be understood to be limited to the exemplary system 100, or the exemplary computing device 200, the systems and the computing devices herein should not be understood to be limited to the exemplary method 300.

As shown in FIG. 3, the management service 110 initially receives, via the processor 202, a request from the consumer 114 to join the consumer network, at 302, as well as consent from the consumer 114 to be included. The consent may be provided by the consumer 114, to the management service 110, in any suitable manner including via interfaces displayed to the consumer 114 at the computing device 200 by the management service 110, etc.

At 304, the management service 110 accesses transaction data for the consumer 114, and multiple other consumers (e.g., consenting consumers, etc.) to be included in the consumer network, via the data structure 118 (e.g., the payment network 106 provides the management service 110 with access to the transaction data stored in the data structure 118, etc.). In so doing, the management service 110 accesses all of the transaction data stored in the data structure 118, for all consumers (including the consumer 114) associated with the system 100 and/or the payment network 106. In this manner, all possible consumers available to the management service 110 can be included in the consumer network and potentially linked with the consumer 114. Alternatively, the management service 110 may access transaction data for only select consumers (e.g., a particular group of consumers, etc.), for example, that have consented (or otherwise identified themselves to the management service 110 as willing) to participate in the consumer network, that satisfy a particular demographic requirement, etc.

Next, at 306, the consumer 114 and all other consumers whose transaction data have been accessed are correlated by the management service 110, via the processor 202, based on their corresponding transaction data (e.g., to determine preliminary links between the consumers, etc.). In so doing, the management service 110 identifies, by analyzing the available transaction data, similar transaction behaviors between the consumers, and similar product and/or service preferences. For example, the management service 110 may identify consumers that shop at similar locations (e.g., geographic locations, etc.), that shop at similar or the same merchants, that purchase similar or the same products, that spend similar amounts in transactions, etc. Or, other bases may be used to identify consumers. As part of this operation, the management service 110 may also analyze multiple different levels of the consumers and/or the merchants with whom the consumers have transacted for further correlations.

After the consumers are correlated (to the desired extent), the management service 110 then identifies at 308, via the processor 202, links between the consumers based on the correlations. More particularly, the identified links are based on predefined strengths or characteristics of the correlations between the consumers. For example, the management service 110 identifies links for the consumer 114 (or at least suggests such links for the consumer 114) at 310 with any other consumer in the network having the same billing address as the consumer 114 (e.g., suggesting the consumers reside in the same household, etc.); at 312 with any other consumer in the network that has payment transactions at three or more of the same merchants as the consumer 114; and at 314 with any other consumer in the network that has a payment transaction at the same merchant as the consumer 114, at the same date, and for about the same amount and at about the same time. In addition in the illustrated method 300, the management service 110 identifies links for the consumer 114 at 316 with any other consumer in the network following a specific request.

In some aspects of the method 300, the links are automatically provided to the consumers by the management service 110. In other aspects of the method 300, the links are provided to the consumers by the management service 110 as recommended links. Here, the consumers may be required to accept the links before they are implemented by the management service 110 (i.e., the management service 110 must receive an approval or authorization from the consumers before implementing the links in the consumer network).

Then, at 318, the linked consumers are associated together within the consumer network. And, when desired (e.g., when requested by the consumer 114, etc.), the management service 110 causes, via the processor 202, data to be displayed, at 320, to the consumer 114 at the consumer's computing device 200 (e.g., via the output device 206, etc.) for one or more products purchased by at least one of the consumers in the consumer network linked to the consumer 114 (and/or data for one or more merchants at which such products were purchased). In this manner, the consumer 114 can obtain data relating to products and/or services the consumer 114 intends to purchase. In some exemplary embodiments, the management service 110 may also enable, via the processor 202, communication between the consumer 114 and one or more other consumers in the consumer network linked to the consumer 114 (e.g., as part of a live communication option, etc.).

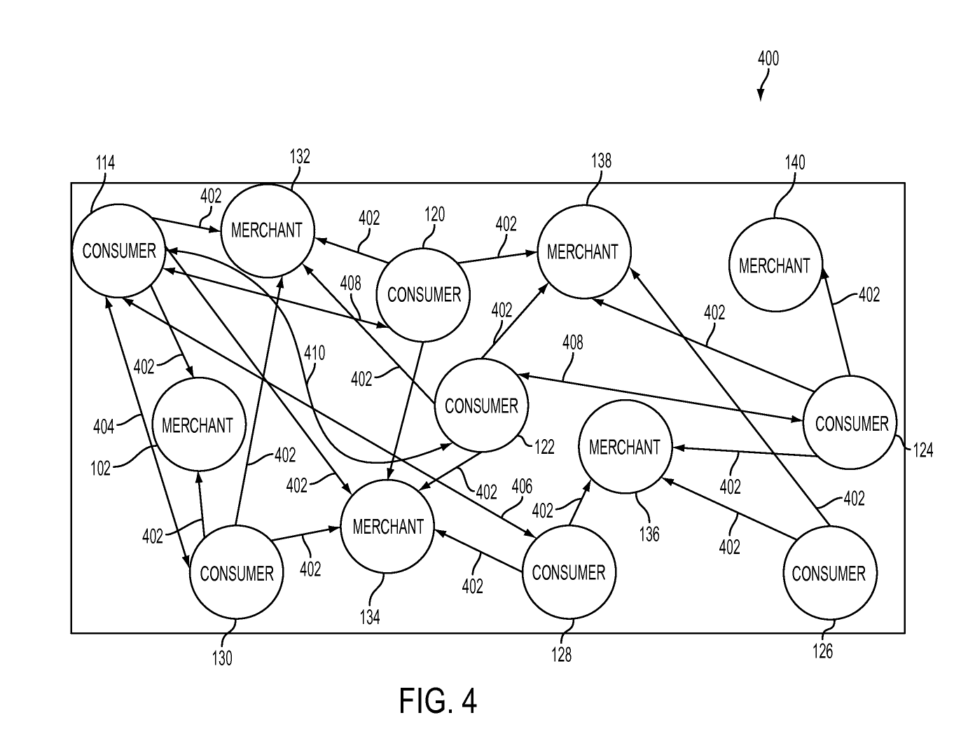

FIG. 4 illustrates an exemplary consumer network 400 provided by the management service 110, via the processor 202, in accordance with the method 300. The consumer network 400 includes consumer 114 as well as additional consumers 120-130 (broadly, consumer nodes) (all of which are accommodated by the system 100), and merchant 102 as well as additional merchants 132-140 (broadly, merchant nodes) (again all of which are accommodated by the system 100).

In the illustrated network 400, links 402 represent consumer-to-merchant links that are initially established, by the management service 110, when the consumers 114 and 120-130 shop at the merchants 102 and 132-140. Over time, all merchants that the consumers have relationships with (e.g., shop at, etc.) will end up being assigned a consumer-to-merchant link 402. As such, it can be seen that additional merchants can be introduced by the management service 110 into the consumer network 400 as desired. In some implementations, the consumer-to-merchant links 402 may be established automatically in the network 400 when the consumers 114 and 120-130 shop at the merchants 102 and 132-140. In other implementations, the consumer-to-merchant links 402 may be established only after approval by the consumers 114 and 120-130 (and, in some cases, even independent of whether or not the consumers 114 and 120-130 shopped at the merchants 102 and 132-140).

Link 404 represents a consumer-to-consumer link that is based on similar consumer-to-merchant links 402 for consumers 114 and 120-130. The consumer-to-consumer link 404 is established, by the management service 110, between any two of the various consumers 114 and 120-130 in the network 400 that have a significant overlap of consumer-to-merchant links 402. In the consumer network 400, consumer 114 and consumer 130 both have consumer-to-merchant links 402 with merchants 102, 132, and 134. As such, consumer 114 and consumer 130 are linked, by the management service 110, via the consumer-to-consumer link 404.

Link 406 represents a consumer-to-consumer link that is based on consumers residing in the same household (e.g., consumers having a common mailing address, etc.). The consumer-to-consumer link 406 is established, by the management service 110, between any two of the various consumers 114 and 120-130 in the network 400 that reside in the same household and, in some cases, also agree (or consent) to the link 406. In the consumer network 400, consumer 114 and consumer 128 belong to the same household and are linked, by the management service 110, via the consumer-to-consumer link 406.

Link 408 represents a consumer-to-consumer link that is based on common purchases by two of the consumers 114 and 120-130 in the network 400. The consumer-to-consumer link 408 is established, by the management service 110, between any two of the consumers 114 and 120-130 that share or split a check/bill at one or more of the merchants 102 and 132-140. In the consumer network 400, consumer 122 and consumer 124 purchased meals at merchant 138 and split the bill/check. Both consumers 122 and 124 therefore show a transaction at the merchant 138 at the same date/time for the same amount. As such, consumer 122 and consumer 124 are linked, by the management service 110, via the consumer-to-consumer link 408.

And, link 410 represents a consumer-to-consumer link that is based on consumer consent. The consumer-to-consumer link 410 is established, by the management service 110, for any consumer with another consumer via invitation, mutual consent, etc. In the consumer network 400, consumer 114 and consumer 122 are linked, by the management service 110, via the consumer-to-consumer link 410.

In some aspects of the consumer network 400, based on the correlations of the various consumers 114 and 120-130, the management service 110 may simply recommend one or more of the different consumer-to-consumer links 404-410 to the consumers 114 and 120-130, as appropriate. The consumers 114 and 120-130 are then required to accept the recommendations before the management service 110 implements the links 404-410 in the network 400. In addition, in some aspects of the network 400, the consumers 114 and 120-130 may choose to stay anonymous or mutually agree to be visible to each other or only to select consumers. In some aspects, similar correlations may also be used by the management service 110 to suggest, to the consumers 114 and 120-130, links with various merchants 102 and 132-140.

In some embodiments, consumers may link in networks with merchants. In these embodiments, the consumers may or may not also be linked with other consumers in the networks. For example, in one implementation, a management service initially accesses transaction data, from a data structure, for a group of consumers and then correlates the consumers with merchants based, at least in part, on the transaction data (in similar fashion to the description in method 300, but with application to a consumer-merchant link). The management service then identifies one or more links between the consumers and the merchants, and associates the linked consumers and merchants within a network (again, in similar fashion to the description in method 300, but with application to a consumer-merchant link). Here, the linked merchants in the network may be able to view one or more products purchased by the linked consumers. In some aspects, consent may be required, on the part of the consumers, to ultimately establish the links with the merchants.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) accessing transaction data, from a data structure, for a group of consumers where the data structure includes transaction data associated with multiple consumers; (b) correlating consumers in the group based, at least in part, on the transaction data for the consumers; (c) identifying links between consumers in the group based on the correlations; (d) associating the linked consumers within a consumer network; (e) causing data to be displayed, to at least one of the linked consumers in the consumer network, for one or more products purchased by at least another one of the linked consumers in the consumer network; and (f) receiving consent from the consumers in the group to be associated with the consumer network.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in providing a consumer network based on transaction data for consumers, the method comprising:
accessing transaction data, from a data structure, for a group of consumers, the data structure including transaction data associated with multiple consumers;
correlating, at a computing device, consumers in the group based, at least in part, on the transaction data for the consumers;
identifying, at the computing device, links between consumers in the group based on the correlations;
associating, at the computing device, the linked consumers within a consumer network; and
causing data to be displayed, to at least one of the linked consumers in the consumer network, for one or more products purchased by at least another one of the linked consumers in the consumer network.

2. The method of claim 1, further comprising receiving, at the computing device, consent from the consumers in the group to be associated with the consumer network.

3. The method of claim 1, wherein the transaction data that serves as the basis for correlating the consumers includes transaction data associated with purchases of products and/or services by the consumers at one or more common merchants.

4. The method of claim 3, wherein the group of consumers includes a first consumer and a second consumer; and
wherein identifying links between consumers includes identifying a link between the first consumer and the second consumer when the transaction data of the first consumer and the transaction data of the second consumer both include purchases at the one or more common merchants.

5. The method of claim 4, wherein the one or more common merchants includes at least three common merchants.

6. The method of claim 3, wherein the group of consumers includes a first consumer and a second consumer; and
wherein identifying links between consumers includes identifying a link between the first consumer and the second consumer when the transaction data of the first consumer and the transaction data of the second consumer both include purchases at the one or more common merchants at about the same time.

7. The method of claim 1, wherein the group of consumers includes a first consumer and a second consumer; and
wherein identifying links between consumers includes identifying a link between the first consumer and the second consumer when a payment account associated with the first consumer and a payment account associated with the second consumer have a common billing address.

8. The method of claim 1, wherein the group of consumers includes a first consumer; and
wherein identifying links between consumers includes identifying a link between the first consumer and a second consumer when the first consumer communicates an invitation to the second consumer to join the consumer network.

9. A system for use in providing a consumer network based on transaction data for consumers, the system comprising:
a memory including a data structure of consumers and transaction data associated with the consumers; and
a processor coupled to the memory, the processor configured to execute instructions, stored in the memory, to cause the processor to:
access transaction data from the data structure for a group of consumers;
link consumers in the group based, at least in part, on the transaction data for the consumers; and
associate the linked consumers within a consumer network;
whereby each linked consumer in the consumer network is able to view one or more products purchased by at least another linked consumer in the consumer network.

10. The system of claim 9, wherein the processor is configured to execute instructions stored in the memory to cause the processor to link select ones of the consumers in the group when the transaction data for each of the select ones of the consumers includes purchases at one or more common merchants.

11. The system of claim 10, wherein the processor is further configured to execute instructions stored in the memory to cause the processor to link the select ones of the consumers in the group with the one or more common merchants.

12. The system of claim 9, wherein the processor is configured to execute instructions stored in the memory to cause the processor to link select ones of the consumers in the group when payment accounts associated with the select ones of the consumers have a common billing address.

13. The system of claim 9, wherein the processor is configured to execute instructions stored in the memory to cause the processor to link select ones of the consumers in the group based on one or more invitations to join the consumer network.

14. The system of claim 9, wherein the processor is configured to execute instructions stored in the memory to cause the processor to display data, to at least one of the consumers in the consumer network, for one or more products purchased by at least another one of the consumers in the consumer network.

15. A non-transitory computer readable media comprising computer-executable instructions that, when executed by at least one processor, cause the at least one processor to:
access transaction data, from a data structure, for a group of consumers, the data structure including transaction data associated with multiple consumers;
correlate consumers in the group based, at least in part, on the transaction data for the consumers;
identify links between the consumers in the group based on the correlations; and
associate the linked consumers from the group within a consumer network;
whereby each linked consumer in the consumer network is able to view one or more products purchased by at least another linked consumer in the consumer network.

16. The non-transitory computer readable media of claim 15, wherein the computer-executable instructions, when executed by the at least one processor, cause the at least one processor to:
identify a link between at least one of the consumers in the group and a merchant;
associate the linked at least one of the consumers and the merchant within the consumer network;
whereby the linked merchant in the consumer network is able to view one or more products purchased by the linked at least one of the consumers in the consumer network.

17. The non-transitory computer readable media of claim 15, wherein the computer-executable instructions, when executed by the at least one processor, cause the at least one processor to identify links between the consumers in the group when the transaction data of the consumers includes purchases at one or more common merchants.

18. The non-transitory computer readable media of claim 15, wherein the computer-executable instructions, when executed by the at least one processor, cause the at least one processor to identify links between the consumers in the group when payment accounts associated with the consumers have a common billing address.

19. The non-transitory computer readable media of claim 15, wherein the computer-executable instructions, when executed by the at least one processor, cause the at least one processor to transmit a request, to the consumers in the group, to confirm the identified links before the linked consumers are associated within the consumer network.

20. The non-transitory computer readable media of claim 15, wherein the computer-executable instructions, when executed by the at least one processor, cause the at least one processor to display data, to at least one of the consumers in the consumer network, for one or more products purchased by at least another one of the consumers in the consumer network.
